(19) United States
(12) Patent Application Publication
(10) Pub. No.: US 2026/0226795 A1
(43) Pub. Date: Aug. 6, 2026

(54) WAND ASSEMBLY FOR USE WITH A RETRACTABLE PULL CORD SYSTEM IN AN ARCHITECTURAL-STRUCTURE COVERING

(71) Applicant: Hunter Douglas Inc., New York, NY (US)

(72) Inventors: Jeffrey L. Spray, Erie, CO (US); Mark Schwandt, Thornton, CO (US); Brayan Martinez, Broomfield, CO (US); David B. McNeill, Denver, CO (US)

(21) Appl. No.: 19/150,734

(22) PCT Filed: Jan. 11, 2024
(86) PCT No.: PCT/US2024/011173

§ 371 Date: Jul. 24, 2025

Related U.S. Application Data
(60) Provisional application No. 63/441,224, filed on Jan. 26, 2023.

(51) Int. Cl. E06B 9/78; E06B 9/42

(52) U.S. Cl. CPC E06B 9/78; E06B 9/42; E06B 2009/785

(57) ABSTRACT

An architectural-structure covering including a covering moveable between extended and retracted positions, a rotatable member operatively associated with the covering, an operating system operatively associated with the rotatable member, an operating element (e.g., retractable pull cord), and a wand assembly configured to receive the operating element therein. The wand assembly includes an outer tube and an inner rod. In use, the outer tube is coupled to, or associated with, the operating system. The inner rod is coupled to, or associated with, the retractable pull cord. A portion of the inner rod is positioned within the outer tube. The inner rod is moveable relative to the outer tube so that movement of the inner rod relative to the outer tube moves the retractable pull cord to move the covering. Meanwhile, simultaneously, the retractable pull cord remains concealed by, contained within, etc. the wand assembly (e.g., outer tube).

### CROSS-REFERENCE TO RELATED APPLICATIONS

The present application is a US national phase entry of International Patent Application No. PCT/US 2024/011173, filed Jan. 11, 2024, which is based upon and claims the benefit of the filing date of, U.S. provisional patent application number 63/441,224, filed Jan. 26, 2023, entitled “Wand Assembly for Use with a Retractable Pull Cord System in an Architectural-Structure Covering,” the entirety of each of which is hereby incorporated by reference herein in its entirety for all purposes.

### FIELD OF THE DISCLOSURE

The present disclosure relates generally to architectural-structure coverings, and more particularly, to a wand assembly for coupling to a retractable pull cord or operating cord used to move the covering between extended and retracted positions. The wand assembly enables the retractable pull cord or operating cord to be contained, concealed, etc.

### BACKGROUND OF THE DISCLOSURE

Architectural-structure coverings for architectural openings and/or structures (used interchangeably herein without the intent to limit), such as windows, doors, archways, portions of a wall, and the like, have taken numerous forms for many years. Architectural-structure coverings include coverings, for example, honeycombs or cellular shades, roller blinds, vertical blinds, wood blinds, Roman shades, etc. In use, the covering is movable between an extended position and a retracted position. For example, the covering may be extendable or retractable (e.g., able to be lowered or raised, respectively, in a vertical direction) between an extended position and a retracted position for obscuring and exposing the underlying architectural structure.

To move the covering between the extended and retracted positions, some architectural-structure coverings include a rotatable member (e.g., a rod or a roller). In use, rotation of the rotatable member in a first direction may retract the covering while rotation of the rotatable member in a second, opposite direction may extend the covering. The covering of the architectural-structure covering may be gathered or stacked adjacent to, or wrapped around, the rotatable member. For example, some retractable coverings are raised or lowered as lift cords are wrapped about or unwrapped from the rotatable member. The architectural-structure covering may include lift cords which are coupled to, or associated with, the covering and the rotatable member. In use, rotation of the rotatable member in a first direction wraps the lift cords about the rotatable member causing the covering to retract adjacent to the rotatable member while rotation in a second direction causes the lift cords to unwrap about the rotatable member causing the covering to move in an extended configuration. Alternatively, in various examples, the covering may be wrapped around the rotatable member in the retracted position. For example, some retractable coverings include a flexible covering suspended from the rotatable member. The covering can either be wrapped about the rotatable member to retract the covering or unwrapped from the rotatable member to extend the covering. Alternatively, the covering may be movable in a horizontal direction. Regardless of the form of the covering, rotation of the rotatable member generally causes movement of the covering of the architectural-structure covering.

To actuate movement of the rotatable member, and thus the covering of the architectural-structure covering, an actuating or operating system may be operably associated with the rotatable member. The architectural-structural covering may also include one or more actuating or operating elements, such as, for example, an operating cord or a pull cord, associated with the operating system to move the covering between the retracted position and the extended position. As such, in use, a user may manipulate the operating element to adjust the position of the covering.

In some examples, the architectural-structure covering may further include a bottom rail attached to a lower edge of the covering. The bottom rail may be utilized to add weight along the lower edge of the covering to encourage the covering to drop by gravity during extension.

One known operating system is a pull cord assembly (“PCA”) including a retractable operating element (e.g., a retractable pull cord). One example of a PCA is the ULTRAGLIDE® operating system manufactured and sold by Hunter Douglas, Inc. Generally speaking, the PCA is described in U.S. Pat. No. 6,129,131 , issued Oct. 10, 2000, entitled “Control System for Covering for Architectural Openings,” which utilizes an operating element to drive a unidirectional pull system that intermittently rotates a rotatable member (e.g., a drive shaft) in a single direction to, for example, drive lift cords associated with the covering to raise the covering from the extended position to the retracted position.

Gravity may be utilized to lower the covering from the retracted position to the extended position. Another example of a PCA operating element is described in U.S. Pat. No. 9,890,588, issued on Feb. 13, 2018, entitled “Operating System for a Covering for an Architectural Opening.” Other examples of PCAs include U.S. Pat. No. 11,136,821, issued on Oct. 5, 2020, entitled “Operating System for an Architectural-Structure Covering” and United States Published Patent Application No. 2020/0284094, filed on Feb. 20, 2020, entitled “Operating System for an Architectural-Structure Covering.”

In recent years, various government regulations have been put in place and/or have been proposed to address access to and manipulation of operating elements. For example, regulations are currently proposed that define limits or thresholds related to the user's ability to manipulate or access such operating elements. One option that has been disclosed to address this issue is to provide a device that selectively encases or encloses an accessible portion of the operating element. However, to date, proposed solutions suffer from one or more disadvantages including, for example, making manipulation of the operating element difficult and burdensome on the user.

It is with respect to these and other considerations that the present improvements may be useful.

### SUMMARY

This Summary is provided to introduce a selection of concepts in a simplified form that are further described below in the Detailed Description. This Summary is not intended to identify key features or essential features of the claimed subject matter, nor is it intended as an aid in determining the scope of the claimed subject matter.

Disclosed herein is an architectural-structure covering. The architectural-structure covering may include a covering movable between an extended position and a retracted position. A rotatable member (e.g., a roller, a shaft, etc.) can be associated with, or coupled to, the covering, where rotation of the rotatable member in a first direction moves the covering to the extended position and rotation of the rotatable member in a second direction opposite the first direction moves the covering to the retracted position. An operating system (e.g., a pull cord assembly or PCA) may be operatively associated with the rotatable member and an operating element such as, for example, a retractable operating cord or pull cord, may be operatively associated with the operating system to move the covering between the extended and retracted positions.

In addition, the architectural-structure covering includes a wand assembly including an upper or outer member or tube and a lower or inner member, shaft, or rod. In use, the outer tube is coupled to, or associated with, for example, the operating system. The inner rod is coupled to, or associated with, the operating element (e.g., retractable pull cord). A portion of the inner rod is positioned within the outer tube. The inner rod is moveable such as, for example, telescopic, vertically slidable, etc. relative to the outer tube so that movement of the inner rod relative to the outer tube moves the operating element (e.g., retractable pull cord) to move the covering between the extended position and the retracted position. Meanwhile, simultaneously, the operating element (e.g., retractable pull cord) remains concealed by, contained within, etc. the wand assembly (e.g., outer tube). Thus arranged, the end user can manipulate the position of the covering while the operating element (e.g., retractable pull cord) remains inaccessible to the end user thereby increasing safety considerations associated with using an operating element (e.g., retractable pull cord).

In some examples, an upper end portion of the outer tube is coupled to, or associated with, the operating system. In some examples, the upper end portion of the outer tube is coupled to the operating system via a flexible connector, an overmolded connector, or sleeve. For example, the operating system includes, or is operatively associated with, a barb. In use, the flexible connector is coupled to the barb via, for example, a snap-fit connection. In addition, the flexible connector is coupled to the upper end portion of the outer tube via, for example, an adhesive so that the outer tube, and hence the wand assembly, can bend relative to the headrail to enable, for example, the wand assembly to be parallel to the headrail during shipping.

In some examples, an end portion of the retractable pull cord is coupled to, or associated with, the inner rod. For example, the end portion of the retractable pull cord may include a ferrule. The inner rod such as, the upper end portion of the inner rod, is coupled to a connector, which is also coupled to the ferrule. Thus arranged, the inner rod is coupled to the operating element (e.g., retractable pull cord).

In use, the inner rod is slidable relative to the outer tube until the connector contacts a stop formed in the outer tube to prevent the inner rod from being pulled out of the outer tube and the operating element (e.g., retractable pull cord) from being exposed.

The wand assembly may include a handle portion manipulatable by a user for manipulating the operating element (e.g., retractable pull cord) to move the covering from the retracted position to the extended position.

In one example, an architectural-structure covering is disclosed. The architectural-structure covering including a covering moveable between an extended position and a retracted position; a rotatable member operatively associated with the covering, rotation of the rotatable member in a first direction moving the covering to the extended position, and rotation of the rotatable member in a second direction that is opposite the first direction moving the covering to the retracted position; an operating system operatively associated with the rotatable member; a retractable pull cord operatively associated with the operating system; and a wand assembly arranged and configured to contain the retractable pull cord. The wand assembly including an outer tube including an upper end, a lower end, and a bore extending between the upper and lower ends, the upper end of the outer tube coupled to, or associated with, the operating system; and an inner rod including an upper end and a lower end, the upper end of the inner rod being coupled to, or associated with, the retractable pull cord, at least a portion of the inner rod being positioned within the outer tube, the inner rod being moveable relative to the outer tube so that movement of the inner rod relative to the outer tube moves the retractable pull cord to move the covering from the extended position to the retracted position.

In any preceding or subsequent example, the retractable pull cord is contained within the outer tube.

In any preceding or subsequent example, the wand assembly further includes a flexible connector including an upper end and a lower end, the upper end of the flexible connector being coupled to the operating system, the lower end of the flexible connector being coupled to the upper end of the outer tube.

In any preceding or subsequent example, the lower end of the flexible connector is bonded to the upper end of the outer tube.

In any preceding or subsequent example, the operating system further includes a barb, the upper end of the flexible connector arranged and configured to engage the barb associated with the operating system via a snap-fit connection.

In any preceding or subsequent example, the flexible connector further includes an actuator, a connector, or an overmolded connector arranged and configured to expand and contract so that the upper end of the flexible connector can receive the barb associated with the operating system.

In any preceding or subsequent example, the flexible connector enables the wand assembly to bend or flex relative to a headrail of the architectural-structure covering.

In any preceding or subsequent example, the flexible connector is selected from one of an overmolded connector and a sleeve.

In any preceding or subsequent example, the wand assembly further includes a connector arranged and configured to couple the upper end of the inner rod with the retractable pull cord.

In any preceding or subsequent example, an end portion of the retractable pull cord includes a ferrule, the connector including a plurality of arms arranged and configured to engage the ferrule.

In any preceding or subsequent example, the connector is bonded to the upper end of the inner rod.

In any preceding or subsequent example, the inner rod is moveable relative to the outer tube until the connector contacts a stop formed in the outer tube to prevent the inner rod from being disassembled from the outer tube.

In any preceding or subsequent example, the inner rod includes a handle portion manipulatable by a user for moving the inner rod relative to the outer tube and thus pulling the retractable pull cord to move the covering from the retracted position to the extended position.

In any preceding or subsequent example, the handle portion is associated with the lower end of the inner rod.

In any preceding or subsequent example, the wand assembly further includes a wand guide coupled to the lower end of the outer tube.

In any preceding or subsequent example, the wand guide includes a cap coupled to the lower end of the outer tube, the cap including diametrically opposed arms extending therefrom; and a bottom wand guide including diametrically opposed windows arranged and configured to receive the diametrically opposed arms for coupling the bottom wand guide to the cap.

In any preceding or subsequent example, the cap is bonded to the lower end of the outer tube.

In any preceding or subsequent example, the wand guide further includes a cover arranged and configured to conceal the cap and portions of the bottom wand guide.

In any preceding or subsequent example, the wand assembly further includes a wand guide assembly coupled to the lower end of the outer tube, the wand guide assembly including an outer wand cover including a first end portion, a second end portion opposite the first end portion, and a bore extending from the first end portion to the second end portion, the bore arranged and configured to enable the inner rod to pass therethrough.

In any preceding or subsequent example, the first end portion has an outer diameter corresponding to the outer diameter of the outer tube, the outer wand cover including a tapered outer diameter extending from the first end portion towards the second end portion.

In any preceding or subsequent example, the wand guide assembly further includes a connector including a first end portion and a second end portion, the first end portion of the connector arranged and configured to be received within the bore of the outer tube, the second end portion of the connector including external threads arranged and configured to threadably engage internal threads formed on an inner surface of the outer wand cover.

In any preceding or subsequent example, the first end portion of the connector is bonded within the bore of the outer tube.

In any preceding or subsequent example, the second end portion of the connector includes a plurality of legs extending longitudinally therefrom, the plurality of legs arranged and configured to be received with pockets formed on the inner surface of the outer wand cover.

In any preceding or subsequent example, the inner surface of the outer wand cover further includes a plurality of ramped surfaces arranged and configured to interact with and engage the plurality of legs to flex the plurality of legs until the plurality of legs align with the plurality of pockets.

### BRIEF DESCRIPTION OF THE DRAWINGS

FIG. 1 is a perspective view illustrating an example of an architectural-structure covering;

FIG. 2A is a perspective view illustrating an example of a wand assembly in accordance with one or more features of the present disclosure, the wand assembly may be used in connection with an operating element and the architectural-structure covering shown in FIG. 1;

FIG. 2B is an alternate perspective view illustrating the wand assembly shown in FIG. 2A, certain elements of the wand assembly being transparent for clarity;

FIG. 2C is a detailed, perspective view illustrating an upper portion of the wand assembly shown in FIG. 2A;

FIG. 2D is a detailed, perspective view illustrating the upper portion of the wand assembly shown in FIG. 2C, certain elements of the wand assembly being transparent for clarity;

FIG. 2E is a detailed, perspective view illustrating the upper portion of the wand assembly shown in FIG. 2C, certain elements of the wand assembly being removed for clarity;

FIG. 2F is a detailed, perspective view illustrating an example of a connector in accordance with one or more features of the present disclosure, the connector arranged and configured to couple an inner rod of the wand assembly to the operating element of the architectural-structure covering, certain elements of the wand assembly being transparent for clarity;

FIG. 2G is a detailed, perspective view illustrating the connector shown in FIG. 2F, certain elements of the wand assembly being removed for clarity;

FIG. 2H is a detailed, perspective view illustrating an example of a wand guide in accordance with one or more features of the present disclosure, the wand guide arranged and configured to associate the inner rod of the wand assembly with the outer tube of the wand assembly;

FIG. 2I is a detailed, perspective view illustrating the wand guide shown in FIG. 2H, certain elements of the wand assembly being removed for clarity;

FIG. 2J is a detailed, perspective view illustrating the wand guide shown in FIG. 2H, certain elements of the wand assembly being removed or transparent for clarity;

FIG. 3A is a detailed, perspective view illustrating an alternate example of a wand guide in accordance with one or more features of the present disclosure, the wand guide arranged and configured to associate the inner rod of the wand assembly with the outer tube of the wand assembly;

FIG. 3B is a perspective view illustrating the wand guide of FIG. 3A, certain elements of the wand assembly being removed for clarity;

FIG. 3C is a perspective view illustrating the wand guide of FIG. 3A, certain elements of the wand assembly being removed for clarity;

FIG. 3D is a perspective view illustrating the wand guide of FIG. 3A, certain elements of the wand assembly being transparent for clarity;

FIG. 3E is an end view illustrating certain features of the wand guide of FIG. 3A in accordance with one or more features of the present disclosure;

FIG. 3F is a cross-section view illustrating certain features of the wand guide of FIG. 3A in accordance with one or more features of the present disclosure; and

FIG. 3G is a perspective view illustrating certain features of the wand guide of FIG. 3A in accordance with one or more features of the present disclosure.

The drawings are not necessarily to scale. The drawings are merely representations, not intended to portray specific parameters of the disclosure. The drawings are intended to depict examples of the disclosure, and therefore are not to be considered as limiting in scope. In the drawings, like numbering represents like elements.

### DETAILED DESCRIPTION

Numerous examples of a wand assembly arranged and configured to be used in connection with an architectural-structure covering will now be described more fully hereinafter with reference to the accompanying drawings, in which examples of the present disclosure are presented. As will be described in greater detail below, in some examples, the wand assembly is arranged and configured to couple to, or be associated with, the operating element (e.g., a retractable pull cord) to move the operating element in the desired direction to selectively move the covering in the retraction direction. The wand assembly encapsulates the operating element to provide increased safety. The wand assembly of the present disclosure may be embodied in many different forms and should not be construed as being limited to the examples set forth herein. Rather, these examples are provided so that this disclosure will convey certain features of the wand assembly to those skilled in the art.

It should be understood that, as described herein, an “example” or an “embodiment” (such as illustrated in the accompanying Figures) may refer to an illustrative representation of an environment or article or component in which a disclosed concept or feature may be provided or embodied, or to the representation of a manner in which just the concept or feature may be provided or embodied. However, such illustrated examples or embodiments are to be understood as merely examples (unless otherwise stated), and other manners of embodying the described concepts or features, such as may be understood by one of ordinary skill in the art upon learning the concepts or features from the present disclosure, are within the scope of the disclosure. In addition, it will be appreciated that while the Figures may show one or more examples or embodiments of concepts or features together in a single example or embodiment of an environment, article, or component incorporating such concepts or features, such concepts or features are to be understood (unless otherwise specified) as independent of and separate from one another and are shown together for the sake of convenience and without intent to limit to being present or used together. For instance, features illustrated or described as part of one example or embodiment can be used separately, or with another example or embodiment to yield a still further example or embodiment. Thus, it is intended that the present subject matter covers such modifications and variations as come within the scope of the appended claims and their equivalents.

As will be described in greater detail herein, in use, the wand assembly includes an upper or outer member or tube (terms used interchangeably herein without the intent to limit or distinguish) and a lower or inner member, shaft, or rod (terms used interchangeably herein without the intent to limit or distinguish). In use, the outer tube is coupled to, or associated with, for example, the operating system (e.g., PCA) of the architectural-structure covering. The inner rod is coupled to, or associated with, the operating element (e.g., retractable pull cord). A portion of the inner rod may be positioned within the outer tube. The inner rod may be moveable such as, for example, telescopically, vertically slidable, etc. relative to the outer tube so that movement of the inner rod relative to the outer tube moves the operating element (e.g., retractable pull cord) to move the covering from, for example, the extended position to the retracted position. Meanwhile, simultaneously, the operating element (e.g., retractable pull cord) remains concealed by, contained within, etc. the wand assembly (e.g., outer tube). Thus arranged, the end user can manipulate the position of the covering while the operating element (e.g., retractable pull cord) remains inaccessible to the end user thereby increasing safety considerations associated with using an operating element (e.g., retractable pull cord).

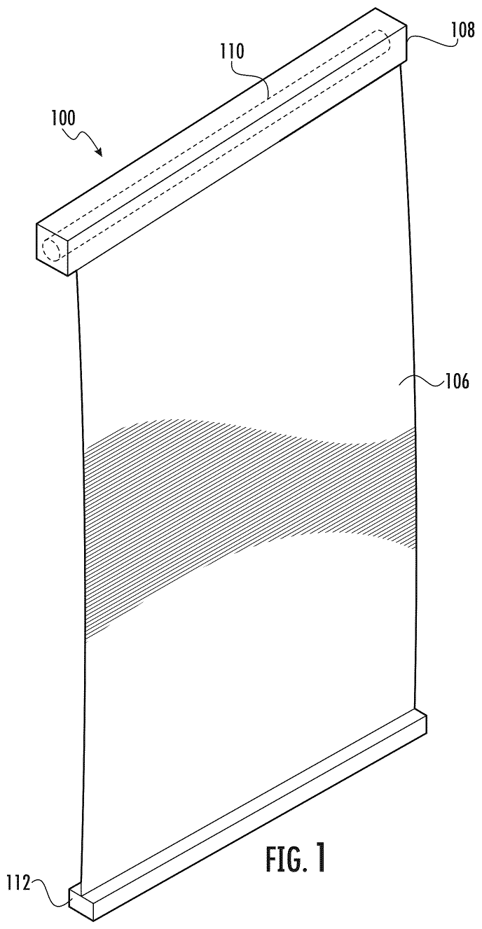

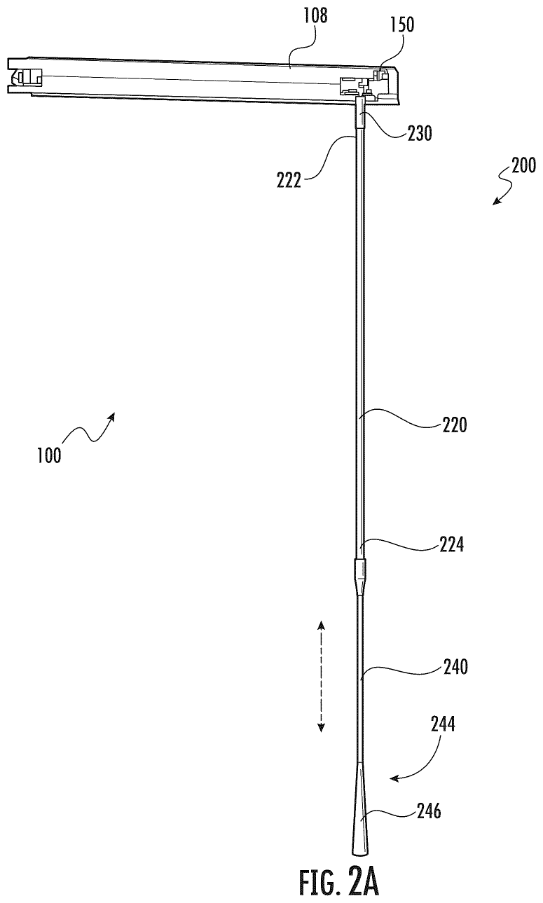

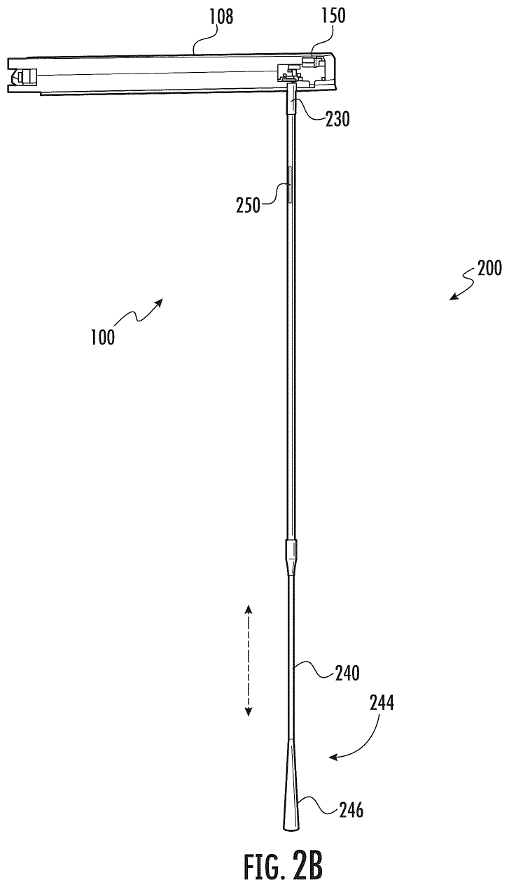

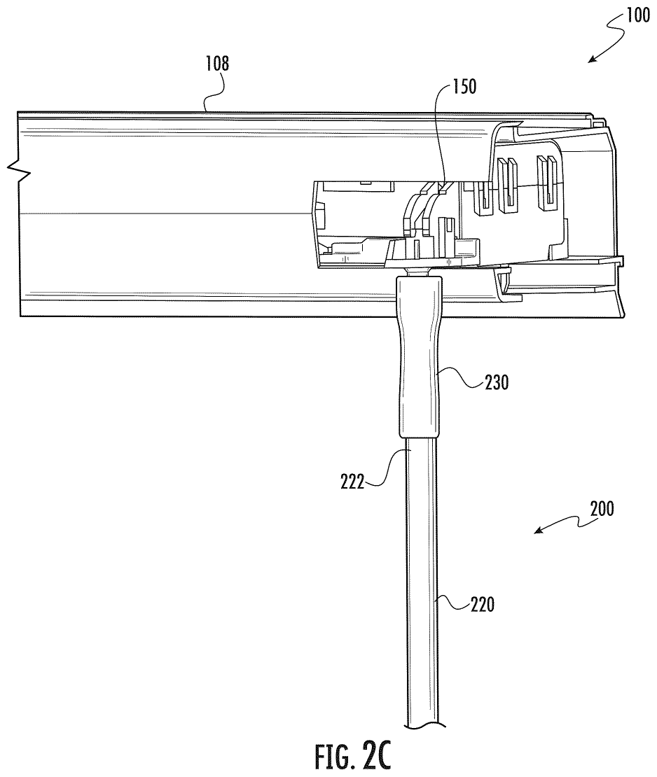

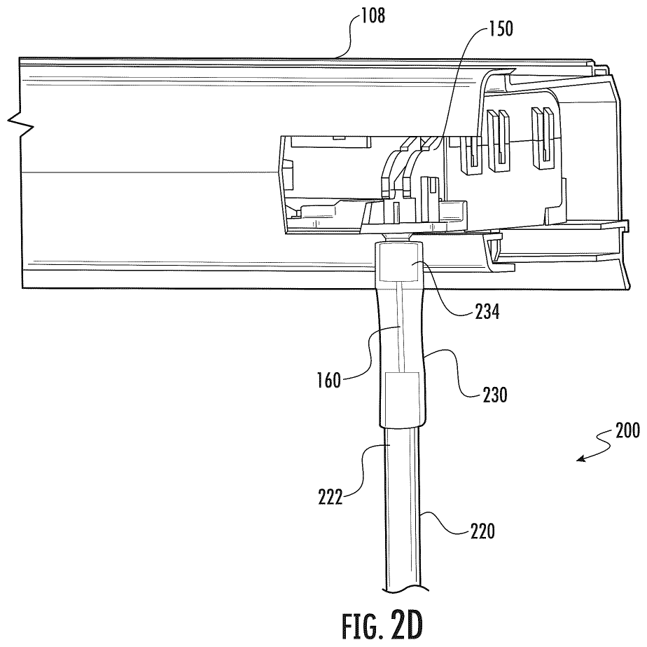

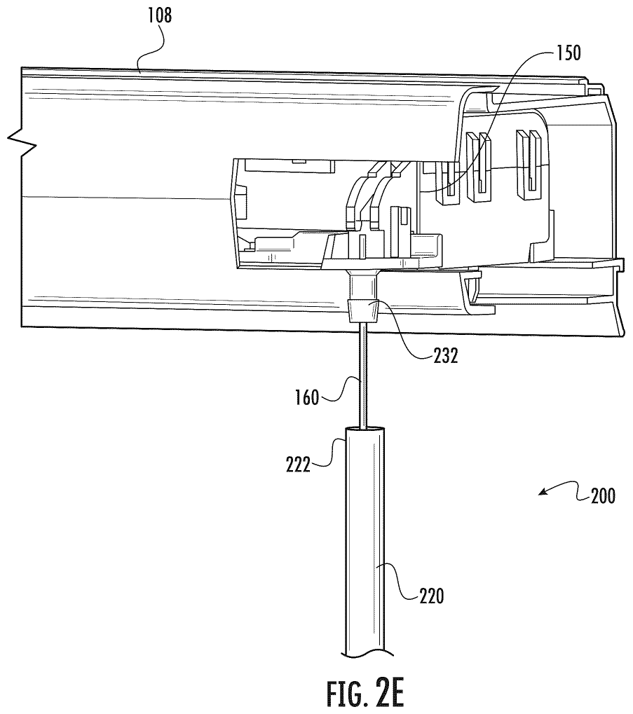

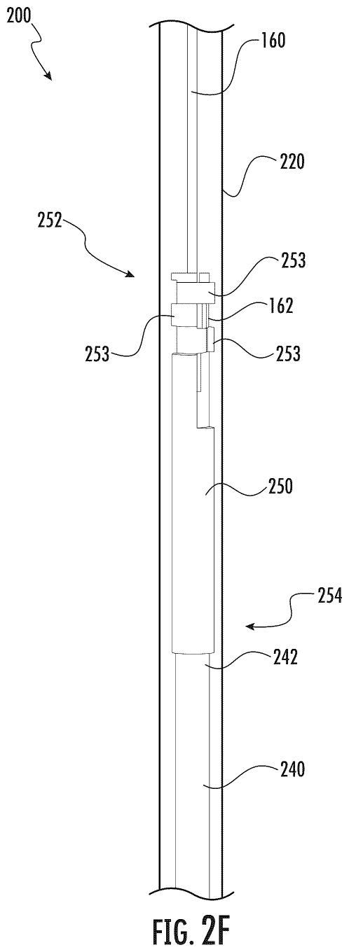

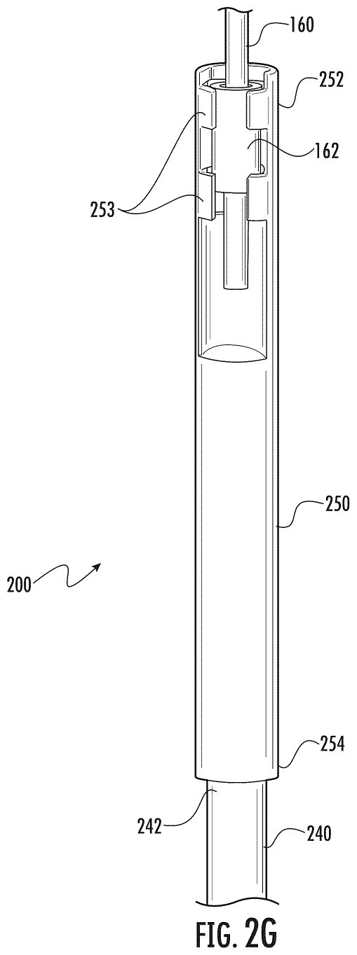

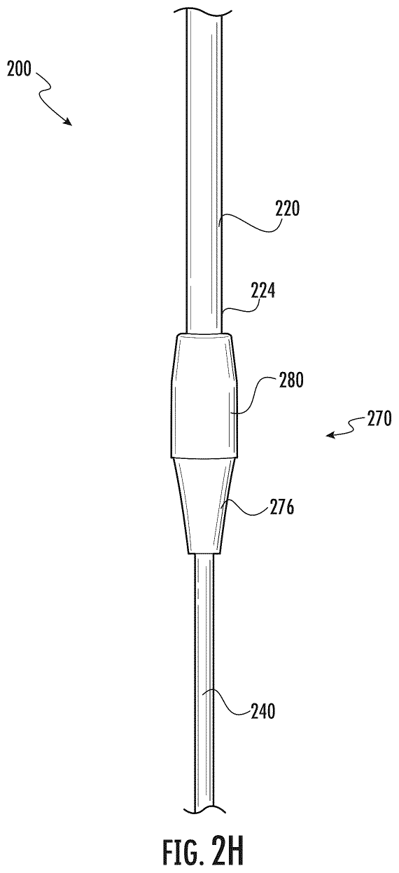

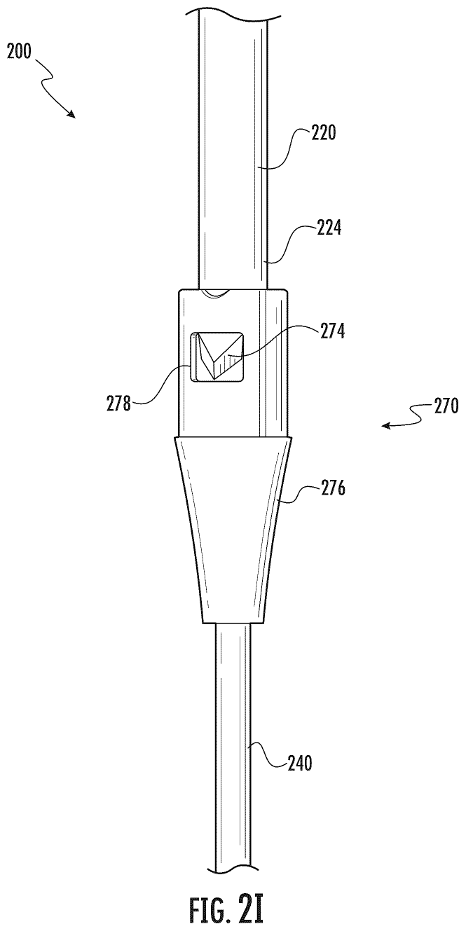

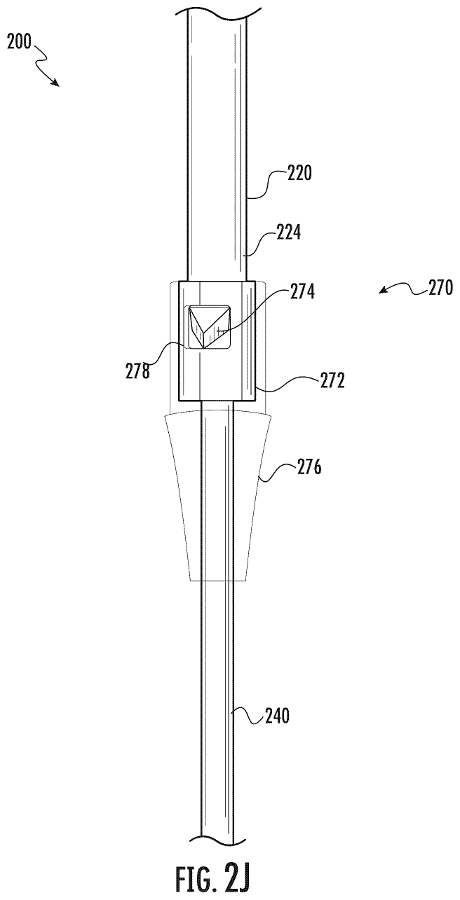

Referring to FIG. 1, an example of an architectural-structure covering 100 that may be used in accordance with the present disclosure is illustrated. The architectural-structure covering 100 may include a covering 106 movable between an extended position and a retracted position, an operating system 150 such as, for example, a PCA (FIGS. 2A-2E), and an operating element such as, for example, a retractable operating cord or pull cord (referred to herein as a retractable pull cord) operatively associated with the operating system 150 to move the covering 106 between the extended and retracted positions. In use, the operating system 150 (e.g., PCA) may be any pull cord assembly including a retractable pull cord now known or hereafter developed including those previously enumerated herein. In accordance with one or more features of the present disclosure, configuration of the operating system 150 remains unchanged other than the connection mechanism or coupler (e.g., barb) as will be described in greater detail below. Thus arranged, in accordance with one or more features of the present disclosure, the wand assembly 200 can be easily coupled to existing architectural-structure coverings including a PCA and retractable pull cord.

As illustrated in FIG. 1, in some examples, the covering 106 may be a flexible material having an upper edge coupled to a rotatable member 110 and a lower edge. A bottom rail 112 may be coupled to the lower edge of the covering 106. However, it should be understood that the covering 106 may be any suitable covering now known or hereafter developed including, for example, a stacked or tiered covering such as, for example, a Roman shade, a cellular shade (e.g., a Honeycomb), a Venetian shade, or the like.

As illustrated, the architectural-structure covering 100 may also include a headrail 108, which may include a housing having opposed end caps (not shown) to form an open-bottom enclosure. The headrail 108 may also include attachments or brackets (not shown) for coupling the headrail 108 to a structure above, or at the top of, an architectural structure, such as a wall, via mechanical fasteners such as screws, bolts, or the like. In use, the headrail 108 may house the rotatable member 110.

Although a particular example of an architectural-structure covering 100 is shown in FIG. 1, many different types and styles of architectural-structure coverings exist and could be employed in place of the example illustrated in FIG. 1. As such, the present disclosure should not be limited to any particular type of architectural-structure covering.

As will be readily appreciated by one of ordinary skill in the art, in use, the operating element is operatively associated with the operating system to move the covering between the extended and retracted positions. As will be shown and described herein, in some examples, the operating element may be in the form of a retractable pull cord 160 (FIGS. 2D-2G). In use, as will be appreciated by one of ordinary skill in the art, pulling or downward movement of the retractable pull cord 160 activates the operating system 150, which rotates the rotatable member, which moves the covering 106 from the extended position to the retracted position. Thereafter, movement of the operating system 150 to a second or disengaged position, causes or permits downward movement of the covering 106 from the retracted position to the extended position via, for example, the force of gravity. However, the operating system may be provided in other forms or configurations such as, for example, a pump UP and pump DOWN system. As such, the operating system should not be limited to any particular type of system unless explicitly claimed. That is, the present disclosure is configured to work in connection with any retractable pull cord assembly now known or hereafter developed. As such, the present disclosure should not be limited to any particular type or configuration of retractable pull cord unless explicitly claimed.

Referring to FIG. 1, for the sake of convenience and clarity, terms such as “front,” “rear,” “top,” “bottom,” “up,” “down,” “vertical,” “horizontal”, “inner,” and “outer” may be used herein to describe the relative placement and orientation of various components and portions of the architectural-structure covering 100, each with respect to the geometry and orientation of the architectural-structure covering 100 as they appear in FIG. 1. Said terminology is intended to be non-limiting and is used herein merely to describe relationship between various components as illustrated in FIG. 1.

Referring to FIGS. 2A-2J, in some examples, the architectural-structure covering 100 further includes a wand assembly 200. As will be described in greater detail below, the wand assembly 200 includes a first, upper or outer member or tube 220 (referred to herein as an outer tube) and a second, lower or inner member or rod 240 (referred to herein as an inner rod). In use, as illustrated, the outer tube 220 is coupled to, or associated with, for example, the operating system such as, for example, operating system 150. The inner rod 240 is coupled to, or associated with, the operating element (e.g., retractable pull cord 160). A portion of the inner rod 240 is positionable within the outer tube 220. The inner rod 240 can be moveable such as, for example, telescopic, vertically slidable, etc. relative to the outer tube 220 so that movement of the inner rod 240 relative to the outer tube 220 moves the operating element (e.g., retractable pull cord 160) to move the covering such as, for example, covering 106, from the extended position to the retracted position. Meanwhile, simultaneously, the operating element (e.g., retractable pull cord 160) remains concealed by, contained within, etc., the wand assembly 200 (e.g., outer tube 220). Thus arranged, the end user can manipulate the position of the covering 106 while the operating element (e.g., retractable pull cord 160) remains inaccessible to the end user thereby increasing safety considerations associated with using an operating element (e.g., retractable pull cord 160).

In some examples, as illustrated, the outer tube 220 include a first or upper end portion 222, a second or lower end portion 224, and a bore extending the entire length thereof from the first or upper end portion 222 to the second or lower end portion 224. In some examples, the first or upper end portion 222 of the outer tube 220 is coupled to,, or associated with, for example, the operating system 150. In use, the first or upper end portion 222 may be coupled to, or associated with, the operating system 150 by any suitable mechanism now known or hereafter developed such as, for example, a ball and socket connection. In some examples, the first or upper end portion 222 is coupled to, or associated with, the operating system 150 via a flexible connector 230 such as, for example, an overmolded connector, a flexible sleeve, etc. (terms used interchangeably herein without the intent to limit or distinguish). For example, as best illustrated in FIGS. 2C-2E, the operating system 150, which is shown as retractable pull cord assembly, includes, or is operatively associated with, a barb 232. In use, the flexible connector 230 is coupled to the barb 232 and to the first or upper end portion 222 of the outer tube 220 so that the outer tube 220, and hence the wand assembly 200, can bend relative to the headrail 108 to enable, for example, the wand assembly 200 to be parallel to the headrail 108 during shipping.

In some examples, as illustrated, the flexible connector 230 includes, or is operatively associated, with an actuator or a connector 234 such as, for example, an overmolded connector arranged and configured to expand and contract to engage the barb 232 associated with the operating system 150. In addition, the flexible connector 230 is coupled to the first or upper end portion 222 of the outer tube 220. In use, the flexible connector 230 may be coupled to the first or upper end portion 222 of the outer tube 220 by any suitable mechanism now known or hereafter developed. For example, the flexible connector 230 may be coupled to the first or upper end portion 222 of the outer tube 220 by an adhesive. Thereafter, the actuator or connector 234, which may also be coupled to the flexible connector 230, may be snap-fitted to the barb 232 associated with the operating system 150. Thus arranged, the outer tube 220 of the wand assembly 200 may be coupled to the operating system 150 by the flexible connector 230.

Meanwhile, the inner rod 240 is coupled to, or associated with, the retractable pull cord 160. In use, the inner rod 240 may be coupled to, or associated with, the retractable pull cord 160 by any suitable mechanism now known or hereafter developed including, for example, an eyelet, pull cord 160 may be passed through an opening formed in the inner rod 240, or the like. In some examples, as best illustrated in FIGS. 2F and 2G, the retractable pull cord 160 may include a ferrule 162 at the end thereof (e.g., an end portion of the retractable pull cord 160 may include an enlarged end portion, connector, or ferrule 152). In addition, as illustrated, the wand assembly 200 may include a connector 250 for coupling the first or upper end portion 242 of the inner rod 240 to the retractable pull cord 160, more specifically, the ferrule 162, which is attached to the retractable pull cord 160 (e.g., the first or upper end portion 242 of the inner rod 240 is coupled to a connector 250 for coupling to the retractable pull cord 160 (e.g., via the ferrule 162)). This is but one configuration and the inner rod 240 may be coupled to the retractable pull cord 160 by other mechanisms. Thus arranged, the inner rod 240 is coupled to the operating element (e.g., retractable pull cord 160).

In use, in some examples, the connector 250 includes a first or upper end portion 252 and a second or lower end portion 254. In use, the second or lower end portion 254 may be arranged and configured to receive the first or upper end portion 242 of the inner rod 240. In some examples, the second or lower end portion 254 may be coupled to the first or upper end portion 242 of the inner rod 240 via an adhesive, a snap-fit connection, or any other suitable connection now known or hereafter developed. The first or upper end portion 252 of the connector 250 may be coupled to the ferrule 162 by any suitable mechanism now known or hereafter developed. For example, as shown, the first or upper end portion 252 of the connector 250 may include a plurality of arms 253 configured to engage the ferrule 162. Thus arranged, the inner rod 240 is coupled to the retractable pull cord 160 via the connector 250.

In some examples, as generally illustrated and as previously mentioned, the inner rod 240 may be configured as a shaft having a first or upper end portion 242 and a second or lower end portion 244. The second or lower end portion 244 may be configured with a handle portion 246. In use, the inner rod 240 including the connector 250 is arranged and configured to move within the bore formed in the outer tube 220 such as, for example, vertically move up and down. Thus arranged, in use, the end user can grip the inner rod 240 such as, for example, the handle portion 246 formed on the second or lower end portion 244 of the inner rod 240. Thereafter, by manipulating the handle portion 246 such as, for example, by pulling down on the handle portion 246, the inner rod 240 is moveable relative to the outer tube 220, which causes the retractable pull cord 160, which is coupled to the inner rod 240 to move relative to the operating system 150, which is coupled to the outer tube 220. As such, pulling down on the handle portion 246 of the inner rod 240 causes the covering 106 to move from an extended position to a retracted position. Thereafter, as desired, in some examples, the operating system 150 may be moved to a disengaged position by, for example, moving the wand assembly 200 in a side-to-side motion, or alternatively, in an in-to-out motion, which allows the covering to drop from the retracted position to the extended position via a force of gravity.

In use, in some examples, the inner rod 240 is slidable relative to the outer tube 220 until the connector 250 contacts a stop formed in the outer tube 220 to prevent the inner rod 240 from being pulled out of the outer tube 220 and the operating element (e.g., retractable pull cord 160) from being exposed. For example, until the connector 250 contacts a stop on the second or lower end portion 224 of the outer tube 220.

With reference to FIGS. 2H-2J, in some examples, the wand assembly 200 may include a wand guide 270 coupled to the second or lower end portion 224 of the outer tube 220. As illustrated, the wand guide 270 may include a cap 272 coupled to the second or lower end portion 224 of the outer tube 220. In use, the cap 272 may be coupled to the second or lower end portion 224 of the outer tube 220 by any suitable mechanism now known or hereafter developed. For example, the cap 272 may be coupled to the second or lower end portion 224 of the outer tube 220 via an adhesive. In some examples, the cap 272 may be internally coupled to or externally coupled to the outer tube 220. As illustrated, the cap 272 may include diametrically opposed arms or barbs 274 extending therefrom. In addition, the wand guide 270 includes a bottom wand guide 276 including diametrically opposed windows 278. In use, the bottom wand guide 276 is arranged and configured to be positioned over the inner rod 240. Thereafter, the bottom wand guide 276 may be coupled to the outer tube 220 by sliding the bottom wand guide 276 over the cap 272 until the arms or barbs 274 formed on the cap 272 snap into the window 278 formed in the bottom wand guide 276. Finally, the wand guide 270 may also include a cover 280 to provide an aesthetically pleasing exterior surface over the cap 272 and portions of the bottom wand guide 276 (e.g., to conceal the cap 272 and portions of the bottom wand guide 276). The cover 280 may be coupled to the bottom wand guide 276 by sliding the cover 280 downwardly over the outer tube 220 and into engagement with the bottom wand guide 276. Thus arranged, the wand guide 270 may be fixedly coupled to the outer tube 220 of the wand assembly 200. In use, the wand guide 270 assists in guiding movement of the inner rod 240 relative to the outer tube 220.

In use, incorporation of the wand guide 270 enables, for example, an installer, a manufacturer, etc., to replace the outer tube 220 and/or the inner rod 240 if needed, for example, if different length outer tubes 220 or inner rods 240 are needed for a particular covering length. That is, for example, in use, the bottom wand guide 276 may be rotated allowing the bottom wand guide 276 to be disconnected from the cap 272.

In some examples, the outer tube 220 may be provided with the flexible connector 230 and the cap 272 permanently or fixedly coupled thereto (e.g., bonded). The inner rod 240 may be provided with the handle portion 246, either integrally formed or coupled thereto, and the connector 250 permanently or fixedly coupled thereto (e.g., bonded). As such, during assembly, in some examples, the inner rod 240 may be positioned within the bore of the outer tube 220. Next, the inner rod 240 can be coupled to the retractable pull cord 160 via the connector 250 as previously described. Thereafter, the flexible connector 230 can be coupled to the operating system 150 by, for example, snap-fitting the flexible connector 230 to the barb 232 associated with the operating system 150. Thereafter, the wand guide 270 may be installed and assemble to associate the inner rod 240 with the outer tube 220 and to prevent accidental disassembly thereof.

In use, the outer tube 220 and the inner rod 240 may have any suitable length. For example, the outer tube 220 may have a length of 19 inches, 20, inches, 21 inches, or the like. In some examples, the inner tube 240 may have a uniform length. Thus arranged, depending on the length of the covering, the assembler may select an outer tube 220 of appropriate length with the length of the outer tube 220 determining the pull stroke of the operating element (e.g., retractable pull cord 160).

In use, the wand assembly 200 including the outer tube 220 and the inner rod 240 may be manufactured from any suitable material such as, for example, a plastic, a fiberglass, a carbon-fiber, a metal, or combinations thereof.

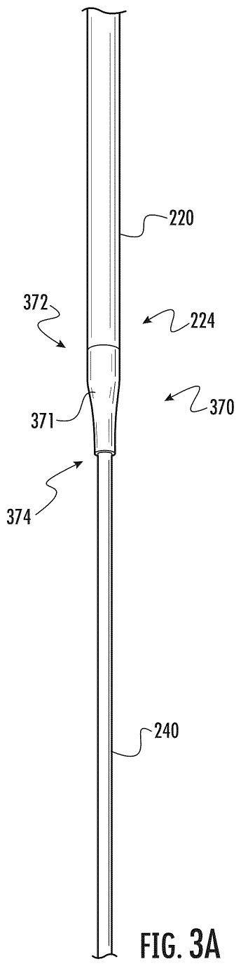

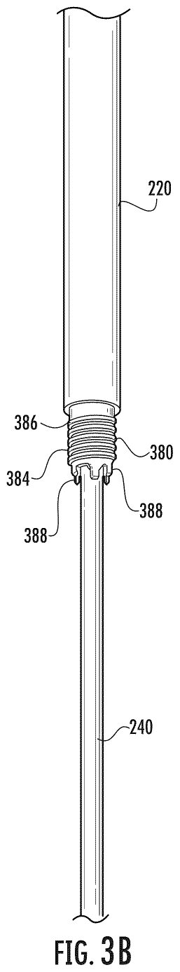

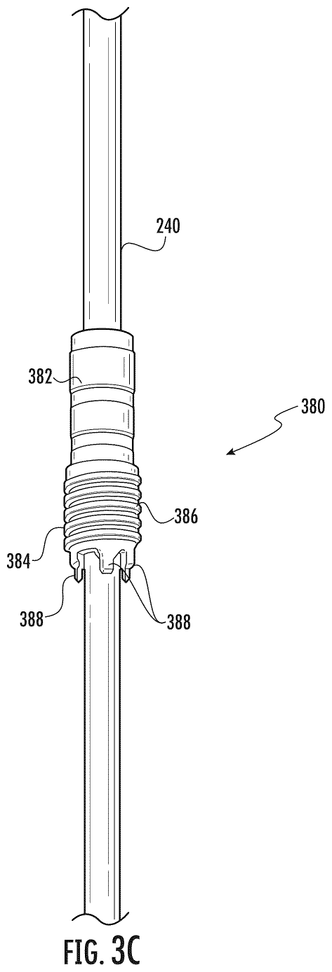

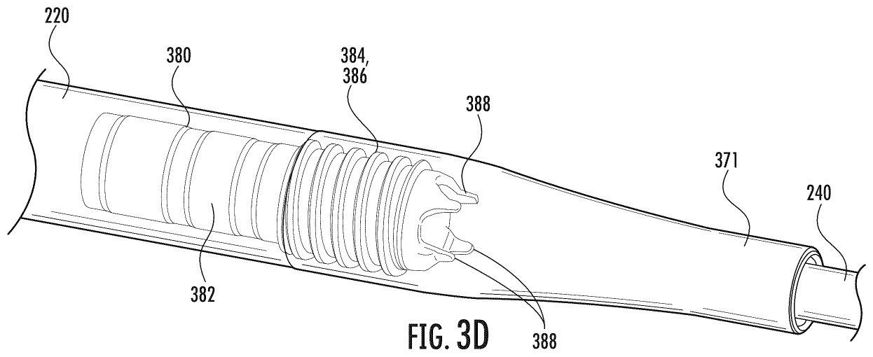

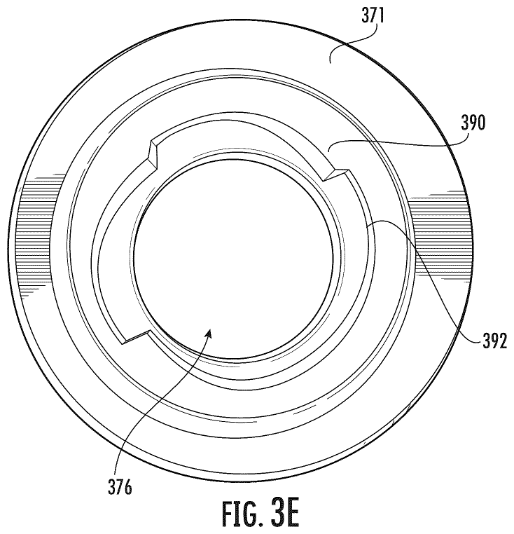

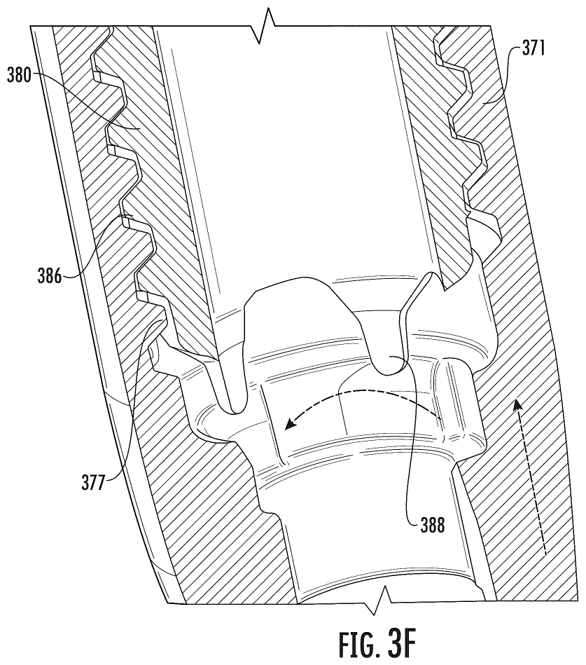

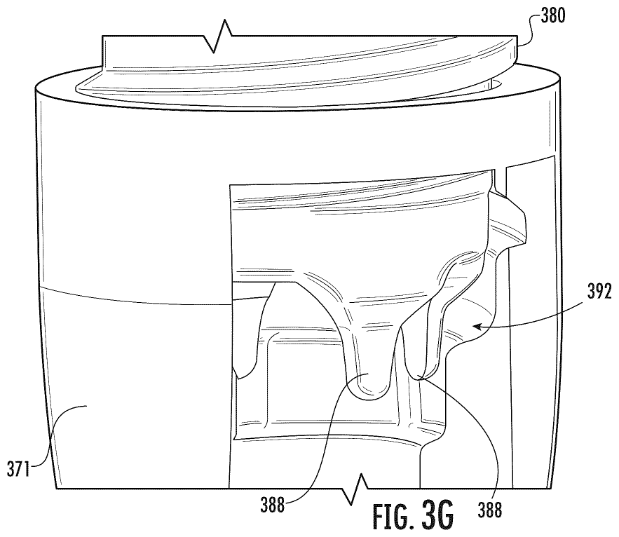

As previously mentioned, the inner rod 240 may be coupled with, associated with, etc. the outer tube 220 by any suitable mechanism now known or hereafter developed such as, for example, the wand guide 270 described above. Alternatively, with reference to FIGS. 3A-3G, an alternate example of a wand guide assembly 370 for associating, coupling, etc. the second or lower end portion 224 of the outer tube 220 with the inner rod 240 is disclosed. As illustrated, the wand guide assembly 370 includes an outer wand cover 371 including a first end portion 372 and a second end portion 374 opposite the first end portion 372. In use, the first end portion 372 is arranged and configured to contact the second or lower end portion 224 of the outer tube 220. In a preferred example, the first end portion 372 includes an outer diameter that is substantially flush or equal to the outer diameter of the outer tube 220.

In addition, as illustrated, the outer wand cover 371 includes a central bore 376 extending from the first end portion 372 to the second end portion 374 so that the inner rod 240 can pass therethrough. As illustrated, in a preferred example, the outer wand cover 371 includes a tapered outer diameter or surface along a portion thereof to provide the outer wand cover 371 with a streamline appearance.

The wand guide assembly 370 further include a connector 380. As illustrated, in some examples, the connector 380 includes a first end portion 382 and a second end portion 384. The first end portion 382 of the connector 380 being arranged and configured to be received within the bore of the outer tube 220 (as best illustrated in FIGS. 3B and 3D). In some examples, the first end portion 382 of the connector 380 can be bonded to the inner diameter of the outer tube 220, although this is but one configuration and other configurations such as, for example, press-fit, snap-fit, threads, or the like, are contemplated.

In some examples, as illustrated, the second end portion 384 of the connector 380 may include external threads 386. Thus arranged, the external threads 386 formed on the second end portion 384 of the connector 380 threadably engage internal threads 377 formed on the inner surface of the outer wand cover 371 (as best illustrated in FIG. 3F). Thus arranged, the outer wand cover 371 may be threadably coupled to the connector 380, which is coupled to the outer tube 220. As such, the outer wand cover 371 is securely coupled to the outer tube 220.

In addition, as illustrated, in some examples, the second end portion 384 of the connector 380 may include a plurality of projections or legs 388 extending longitudinally therefrom. As illustrated, in some examples, the second end portion 384 of the connector 380 may include four projections or legs 388, although this is but one example and the connector 380 may include more or less projections or legs. In use, the projections or legs 388 are arranged and configured to contact, engage, etc. with pockets 392 formed on the inner surface of the outer wand cover 371 to provide a snap-fit between the connector 380 and the outer wand cover 371, which acts to prevent the outer wand cover 371 from accidentally disengaging (e.g., unscrewing). As best illustrated in FIG. 3E, the inner surface of the outer wand cover 371 may include a plurality of ramped surfaces or ribs 390 to interact with and engage the projections or legs 388 formed on the connector 380. In use, the projections or legs 388 may be arranged and configured to flex inwards to snap over the ramped surfaces or ribs 390. As best illustrated in FIG. 3G, as the outer wand cover 371 is threaded onto the connector 380, the projection or legs 388 interact with, engage, etc. the ramped ribs 390 until the projection or legs 388 are positioned within, dropped into, etc. the pockets 392 defined by the ramped ribs 390.

While the present disclosure refers to certain examples, numerous modifications, alterations, and changes to the described examples are possible without departing from the sphere and scope of the present disclosure, as defined in the appended claim(s). Accordingly, it is intended that the present disclosure not be limited to the described examples, but that it has the full scope defined by the language of the following claims, and equivalents thereof.

The foregoing description has broad application. It should be appreciated that the concepts disclosed herein may apply to many types of coverings, in addition to the roller-type coverings described and depicted herein. The discussion of any example is meant only to be explanatory and is not intended to suggest that the scope of the disclosure, including the claims, is limited to these examples. In other words, while illustrative examples of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, examples, or configurations for the purpose of streamlining the disclosure. However, it should be understood that various features of the certain aspects, examples, or configurations of the disclosure may be combined in alternate aspects, examples, or configurations.

Moreover, the following claims are hereby incorporated into this Detailed Description by this reference, with each claim standing on its own as a separate example of the present disclosure.

As used herein, an element or step recited in the singular and proceeded with the word “a” or “an” should be understood as not excluding plural elements or steps, unless such exclusion is explicitly recited. Furthermore, references to “one example” of the present disclosure are not intended to be interpreted as excluding the existence of additional examples that also incorporate the recited features.

The phrases “at least one,” “one or more,” and “and/or” as used herein, are open-ended expressions that are both conjunctive and disjunctive in operation. The terms “a” (or “an”), “one or more” and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., engaged, attached, coupled, connected, and joined) are to be construed broadly and may include intermediate members between a collection of elements and relative to movement between elements unless otherwise indicated. As such, connection references do not necessarily infer that two elements are directly connected and in fixed relation to each other. All rotational references describe relative movement between the various elements. Identification references (e.g., primary, secondary, first, second, third, fourth, etc.) are not intended to connote importance or priority but are used to distinguish one feature from another. The drawings are for purposes of illustration only and the dimensions, positions, order and relative to sizes reflected in the drawings attached hereto may vary.

What is claimed:

1. An architectural-structure covering comprising:
a covering moveable between an extended position and a retracted position;
a rotatable member operatively associated with the covering, rotation of the rotatable member in a first direction moving the covering to the extended position, and rotation of the rotatable member in a second direction that is opposite the first direction moving the covering to the retracted position;
an operating system operatively associated with the rotatable member;
a retractable pull cord operatively associated with the operating system; and
a wand assembly arranged and configured to contain the retractable pull cord, the wand assembly including:
an outer tube including an upper end, a lower end, and a bore extending between the upper and lower ends, the upper end of the outer tube coupled to, or associated with, the operating system;
an inner rod including an upper end and a lower end, the upper end of the inner rod being coupled to, or associated with, the retractable pull cord, at least a portion of the inner rod being positioned within the outer tube, the inner rod being moveable relative to the outer tube so that movement of the inner rod relative to the outer tube moves the retractable pull cord to move the covering from the extended position to the retracted position.

2. The architectural-structure covering of claim 1, wherein the retractable pull cord is contained within the outer tube.

3. The architectural-structure covering of claim 1, wherein the wand assembly further comprises a flexible connector including an upper end and a lower end, the upper end of the flexible connector being coupled to the operating system, the lower end of the flexible connector being coupled to the upper end of the outer tube.

4. The architectural-structure covering of claim 3, wherein the lower end of the flexible connector is bonded to the upper end of the outer tube.

5. The architectural-structure covering of claim 3, wherein the operating system further comprises a barb, the upper end of the flexible connector arranged and configured to engage the barb associated with the operating system via a snap-fit connection.

6. The architectural-structure covering of claim 5, wherein the flexible connector further comprises an actuator, a connector, or an overmolded connector arranged and configured to expand and contract so that the upper end of the flexible connector can receive the barb associated with the operating system.

7. The architectural-structure covering of claim 3, wherein the flexible connector enables the wand assembly to bend or flex relative to a headrail of the architectural-structure covering.

8. The architectural-structure covering of claim 7, wherein the flexible connector is selected from one of an overmolded connector and a sleeve.

9. The architectural-structure covering of claim 1, wherein the wand assembly further comprises a connector arranged and configured to couple the upper end of the inner rod with the retractable pull cord.

10. The architectural-structure covering of claim 9, wherein an end portion of the retractable pull cord includes a ferrule, the connector including a plurality of arms arranged and configured to engage the ferrule.

11. The architectural-structure covering of claim 10, wherein the connector is bonded to the upper end of the inner rod.

12. The architectural-structure covering of claim 9, wherein the inner rod is moveable relative to the outer tube until the connector contacts a stop formed in the outer tube to prevent the inner rod from being disassembled from the outer tube.

13. The architectural-structure covering of claim 1, wherein the inner rod includes a handle portion manipulatable by a user for moving the inner rod relative to the outer tube and thus pulling the retractable pull cord to move the covering from the retracted position to the extended position.

14. The architectural-structure covering of claim 11, wherein the handle portion is associated with the lower end of the inner rod.

15. The architectural-structure covering of claim 1, wherein the wand assembly further comprises a wand guide coupled to the lower end of the outer tube.

16. The architectural-structure covering of claim 15, wherein the wand guide includes:
a cap coupled to the lower end of the outer tube, the cap including diametrically opposed arms extending therefrom; and
a bottom wand guide including diametrically opposed windows arranged and configured to receive the diametrically opposed arms for coupling the bottom wand guide to the cap.

17. The architectural-structure covering of claim 16, wherein the cap is bonded to the lower end of the outer tube.

18. The architectural-structure covering of claim 16, wherein the wand guide further comprises a cover arranged and configured to conceal the cap and portions of the bottom wand guide.

19. The architectural-structure covering of claim 1, wherein the wand assembly further comprises a wand guide assembly coupled to the lower end of the outer tube, the wand guide assembly including an outer wand cover including a first end portion, a second end portion opposite the first end portion, and a bore extending from the first end portion to the second end portion, the bore arranged and configured to enable the inner rod to pass therethrough.

20. The architectural-structure covering of claim 19, wherein the first end portion has an outer diameter corresponding to the outer diameter of the outer tube, the outer wand cover including a tapered outer diameter extending from the first end portion towards the second end portion.

21. The architectural-structure covering of claim 19, wherein the wand guide assembly further includes a connector including a first end portion and a second end portion, the first end portion of the connector arranged and configured to be received within the bore of the outer tube, the second end portion of the connector including external threads arranged and configured to threadably engage internal threads formed on an inner surface of the outer wand cover.

22. The architectural-structure covering of claim 21, wherein the first end portion of the connector is bonded within the bore of the outer tube.

23. The architectural-structure covering of claim 21, wherein the second end portion of the connector includes a plurality of legs extending longitudinally therefrom, the plurality of legs arranged and configured to be received with pockets formed on the inner surface of the outer wand cover.

24. The architectural-structure covering of claim 23, wherein the inner surface of the outer wand cover further includes a plurality of ramped surfaces arranged and configured to interact with and engage the plurality of legs to flex the plurality of legs until the plurality of legs align with the plurality of pockets.
